(19) United States
(12) Patent Application Publication
(10) Pub. No.: US 2004/0117673 A1
(43) Pub. Date: Jun. 17, 2004

(54) Method and apparatus to provide platform load lines

(76) Inventors: Tawfik Arabi, Tigard, OR (US); Michael Stapleton, Portland, OR (US); John Dickerson, Hillsboro, OR (US); Hung-Piao (Matthew) Ma, Portland, OR (US); Michael T. Zhang, Portland, OR (US)

Correspondence Address: EDWIN H. TAYLOR, BLAKELY, SOKOLOFF, TAYLOR & ZAFMAN LLP, 12400 WILSHIRE BOULEVARD, SEVENTH FLOOR, LOS ANGELES, CA, 90025, US

(21) Appl. No.: 10/320,387

(22) Filed: Dec. 17, 2002

(51) Int. Cl. G06F 1/26

(52) U.S. Cl. 713/300

(57) ABSTRACT

A method and apparatus are provided to power a processor coupled to a package. This may include determining a type of processor coupled to the package and adjusting characteristics of a load line to power the processor based on the determined type of processor.

### FIELD

The present invention relates to supplying power to an integrated circuit (IC), e.g., a processor. More particularly, the present invention relates to adjusting or programming load line characteristics of a voltage regulating device coupled to an IC.

### BACKGROUND

Although a background and example embodiments will be described using processors as an example IC, practice of the present invention is not limited thereto.

Electronic components, such as integrated circuits (ICs) may be assembled into packages by physically and electrically coupling them to a substrate, such as a printed circuit board (PCB) to form an “electronic assembly.” The “electronic assembly” can be part of an “electronic system.” Examples of electronic systems may include computers (e.g., desktop, laptop, hand-held, server, Internet appliance, etc.), wireless communications devices (e.g. cellular phones, cordless phones, pagers, etc.), computer-related peripherals (e.g., printers, scanners, monitors, etc.), entertainment devices (e.g., televisions, radios, stereos, tape and compact disc players, video cassette, recorders, MP3 (Motion Picture Experts Group, Audio Layer 3) players, etc.), and the like.

There is an incessant competitive pressure among manufacturers to increase the performance of their equipment. This results in new generations of processors having better performance than previous generations of processors. As such, platforms, circuit boards and motherboards may be built to accommodate more than one type of processor. Unfortunately, different processors and different processes have different reliability and therefore different platform power delivery (i.e., load line) requirements. This may pose significant compatibility issues. For a given platform to work with different processors, the load line of the platform may be designed around the most stringent reliability requirements of the potential processors. As a result, if the platform is operated with one of the potential processors not having the most stringent requirements (i.e., having differing reliability requirements), the platform may develop a frequency loss from its optimized performance.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto.

The following represents brief descriptions of the drawings in which like reference numerals represent like elements and wherein:

FIG. 1A is a graph showing example load lines and frequency loss in an example first platform;

FIG. 1B is a graph showing example load lines and frequency loss in an example second platform;

FIG. 2 shows an example circuit board according to an example embodiment of the present invention;

FIG. 3A shows an example first processor coupled to an adjusting mechanism according to an example embodiment of the present invention;

FIG. 3B shows an example second processor coupled to an adjusting mechanism according to an example embodiment of the present invention;

FIG. 4 is a circuit diagram of an example embodiment of the present invention; and

FIG. 5 is a circuit diagram of an example embodiment of the present invention.

### DETAILED DESCRIPTION

In the following detailed description, like reference numerals and characters may be used to designate identical, corresponding or similar components in differing figure drawings. With regard to the description of any timing signals, the terms HIGH and LOW may be used in a generic sense. Embodiments of the present invention are not limited to the described signals, but may be implemented with a total/partial reversal of any of the HIGH and LOW signals by a change in logic. Additionally, well known power/ground connections to integrated circuits (ICs) and other components may not be shown within the FIGs. for simplicity of illustration and discussion, and so as not to obscure the invention. Further, arrangements may be shown in block diagram form in order to avoid obscuring the invention, and also in view of the fact that specifics with respect to implementation of such block diagram arrangements may be highly dependent upon the platform within which the present invention is to be implemented. That is, such specifics should be well within the purview of one skilled in the art. Where specific details (e.g., circuits) are set forth in order to describe example embodiments of the invention, it should be apparent to one skilled in the art that the invention can be practiced without, or with variation of, these specific details. Finally, it should be apparent that differing combinations of hardwired circuitry may be used to implement embodiments of the present invention. That is, the present invention is not limited to any specific combination of hardware.

Arrangements and embodiments may hereafter be described with respect to a first processor and a second processor. These two processors may represent different generations of processors. In one example, the first processor may be a newer generation of a processor and the second processor may be an older generation of a processor. Embodiments of the present invention are also applicable to different types of processors without regard to their age, performance and/or generation. Embodiments of the present invention are also applicable to more than two ICs or processors.

Embodiments of the present invention may be described with respect to a processor being mounted or coupled to a platform, circuit board or motherboard. While the terms platform, circuit board and motherboard are intended to be used interchangeably, embodiments of the present invention are also applicable to other surfaces and substrates.

Embodiments of the present invention may provide a method that includes determining a type of processor coupled to a package and adjusting characteristics of a load line to power the processor based on the determined type of processor. Embodiments of the present invention may provide a platform feature that recognizes a processor and adjusts its load line for better performance and reliability. Arrangements and embodiments may hereafter be described with respect to the accompanying drawings.

FIG. 1A is an example graph showing first processor frequency loss due to non-optimal compatibility with a platform that is designed to optimize the performance of a second processor. More specifically, FIG. 1A shows a first processor load line when the first processor is plugged into the platform. The reliability of the first processor may be constant along the first processor load line. Hence, the first processor load line may be the optimal load line for the first processor. The load line may be critical to reliability. The first processor load line may be determined based on process and processor reliability equations as well as thermal impedance. In order to ensure that the first processor operates at its maximum “reliable” speed, the platform may be implemented with the load line. To accomplish this, the platform power supply DC/AC electrical impedance may be designed to be equal to the impedance derived from process reliability equations.

However, as stated above, problems may occur when different generations of processors are created because each generation of processor may have a different load line. This is a problem when the platform has a unique load line and multiple processors may be supported on the platform over time.

FIG. 1A also shows a second processor's (platform designed) load line for a second processor to be plugged into the platform. In this platform, the load line may be cost optimized for the second processor and therefore may have a steeper slope than the desired load line for the first processor. For the first processor to be reliable in this platform, the first processor may be tested based on the load line. The difference in the test (minimum) voltage between this load line and the first processor desired load line may reduce the frequency of the first processor. The solid line may represent a mean frequency loss to the first processor when the first processor is plugged into a platform compatible with (or designed to optimize) the second processor. If the first processor load line is implemented on the platform, then the second processor may not operate reliably or may operate inefficiently.

On the other hand, the platform may be designed to maximize both the frequency of the first processor at the expense of the frequency for the second processor. FIG. 1B shows this situation. More specifically, FIG. 1B is a graph showing second processor frequency loss in a platform that is optimized for a first processor.

As shown in FIGS. 1A and 1B, when a common platform is designed to accommodate multiple processors, the platform load line may limit the speed (i.e., frequency) of one or more of the processors.

Embodiments of the present invention may design a platform load line to a lowest desired impedance of any processor that the platform may support. Further, embodiments may include a programmable mechanism that allows a voltage regulator (or voltage regulating device) to change (or dynamically adjust) a slope of the platform load line and ensure reliability when different processors are plugged into the platform. As one example, a package pin (such as a VCC pin or a VSS pin) may be read (e.g. sensed or monitored) by the platform to determine if a first processor or a second processor is plugged into the platform. Thus when a first processor is coupled to the platform, a first processor load line may be implemented by a voltage regulating device when the pin is HIGH (representing the first processor, for example). On the other hand, when a second processor is coupled to the platform, a second processor load line may be implemented by a voltage regulating device when the pin is LOW (representing the second processor, for example). One skilled in the art would understand that this description of HIGH and LOW for the first processor and the second processor, respectively, is one example as other examples are also within the scope of the present invention. That is, other ones of pins and/or parameters may be monitored in the determination as to what type of processor (or IC) has been installed in the platform.

FIG. 2 shows an example circuit board 100 that includes a processor 110 and a voltage regulating device 120 according to an example embodiment of the present invention. Other embodiments and configurations are also within the scope of the present invention. In FIG. 2, the processor 110 may be any one of a plurality of different types of processors such as the above-described first processor and second processor. The processor 110 mounted on the circuit board 100 may be removed and replaced on the circuit board 100 as new generations of processors are developed (or for other reasons). FIG. 2 also shows that the voltage regulating device 120 includes an adjusting mechanism 130 as will be described below. While the adjusting mechanism 130 is shown as being within the voltage regulating device 120, the adjusting mechanism 130 may also be located external (or partly external) to the voltage regulating device 120. In this example, the adjusting mechanism 130 is coupled to the processor 110 by a signal line 135. As will be described below, the signal (or sensing) line 135 may be coupled to a particular pin on the processor 110 such as one of the VCC or VSS pins, for example. In other words, this pin of the processor may be used for a purpose other than being coupled to VSS or VCC. In other embodiments, a plurality of signal lines may couple the adjusting mechanism 130 to the processor 110. In these embodiments, the signal lines may be coupled to more than one pin on the processor 110. The voltage regulating device 120 may supply power to the processor 110 across signal lines 125. Use of a plurality of signal or sense lines 135 is advantageous in that more than two different generations or types of ICs may be able to be sensed.

FIGS. 3A-3B show the coupling of processors to an adjusting mechanism according to an example embodiment of the present invention. Other embodiments and configurations are also within the scope of the present invention. More particularly, FIG. 3A shows a first processor 210 coupled to the adjusting mechanism 130. The first processor 210 may be a chip that includes a pin 217 for coupling to the signal (or sensing) line 135. The pin 217 may be coupled to a VSS pad 215 located within the interior of the chip, for example.

FIG. 3B shows a second processor 220 coupled to the adjusting mechanism 130. The second processor 220 may be a chip that includes a pin 227 for coupling to the signal line 135. The pin 227 may be coupled to a VCC pad 225 located within the interior of the chip, for example.

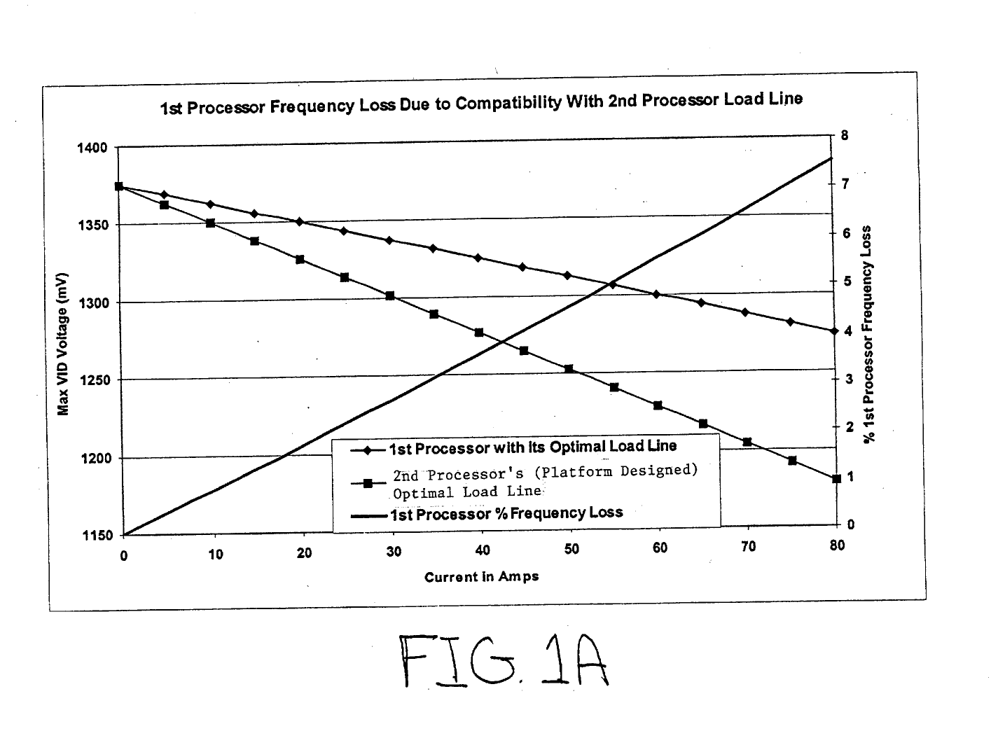

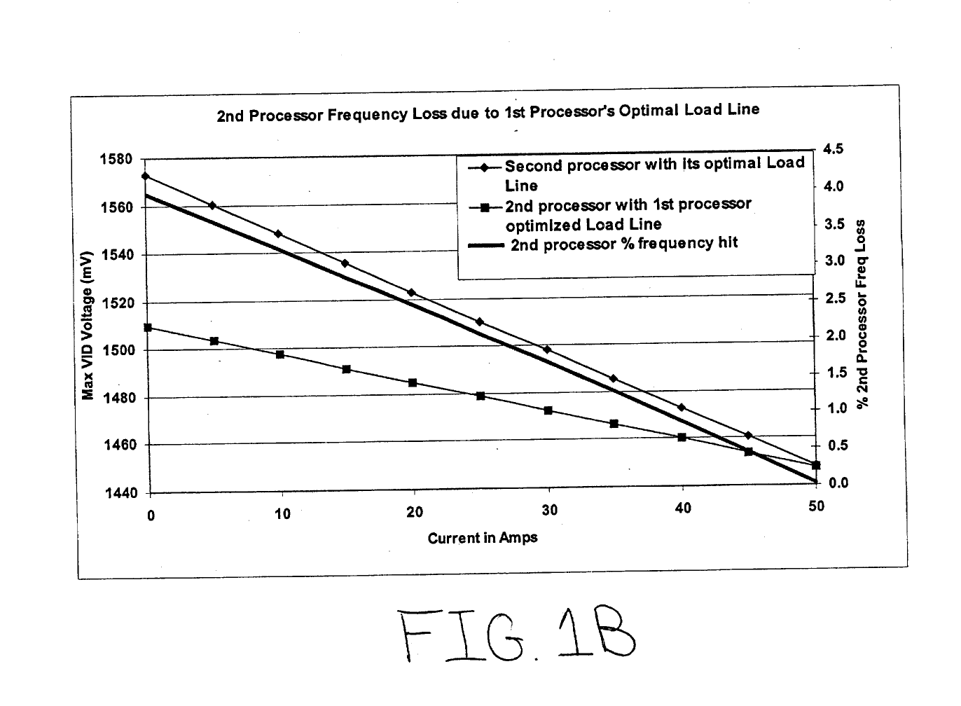

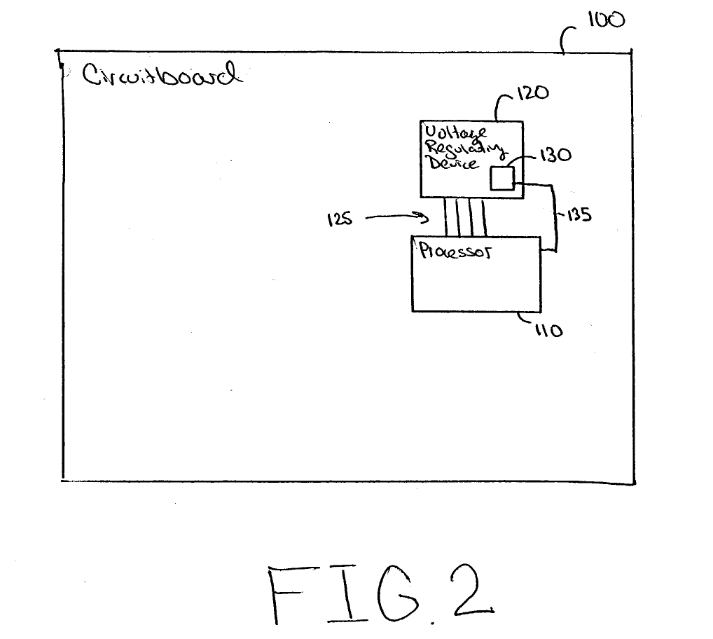

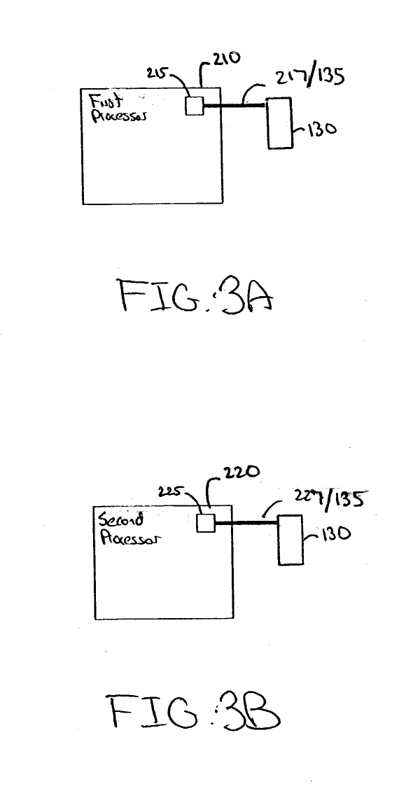

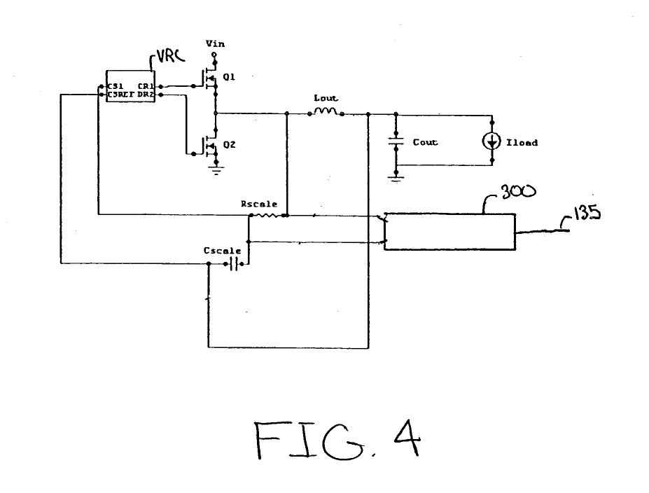

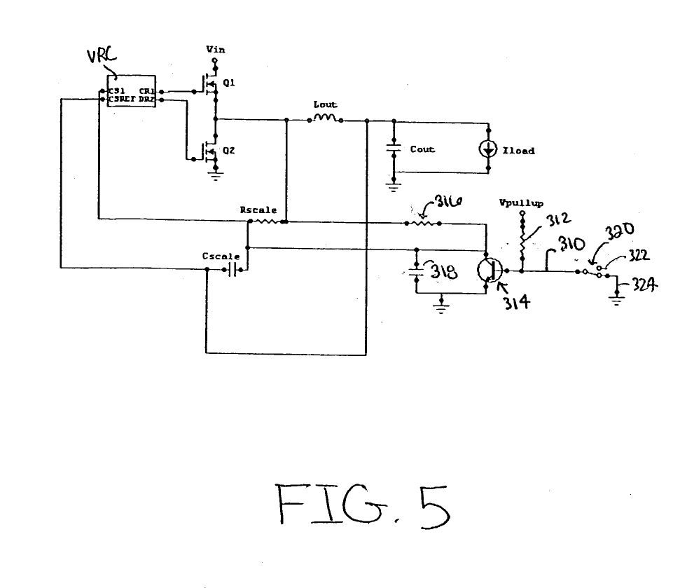

FIG. 4 is a circuit diagram of an example embodiment of the present invention. Other embodiments and configurations are also within the scope of the present invention. FIG. 4 will be described with respect to features such as the voltage regulating device 120, the adjusting mechanism 130 and the processor 110 shown in FIG. 2. More particularly, FIG. 4 shows a voltage regulating device that may be coupled to a processor. The voltage regulating device may output a specific voltage to the processor based on an input current or a sensed value or level. The voltage regulating device shown in FIG. 4 includes a voltage regulator controller VRC, transistors Q1 and Q2, inductor Lout, resistor Rscale, and capacitors Cscale and Cout. Other configurations of the voltage regulating device are also within the scope of the present invention.

In FIG. 4, the voltage regulating device may include an adjusting mechanism 300 coupled to the signal (or sensing) line 135 so as to receive signals or sense values or levels from the processor pin. The adjusting mechanism 300 (FIG. 4) may correspond to the adjusting mechanism 130 (FIG. 2). The voltage regulating device including the adjusting mechanism 300 may apply an output current I load to the processor 110 so as to properly power the processor 110. The adjusting mechanism 300 may control the impedance to change the feedback to the voltage regulating device. The voltage regulating device may therefore output different voltages to the processor coupled to the platform based on different input currents.

The adjusting mechanism 300, in cooperation with the voltage regulating device, may determine a type of processor that is coupled to the package based on signals or sensed values or levels on the signal line 135, and may adjust characteristics of a load line used to power the processor. Stated differently, the adjusting mechanism 300 may adjust characteristics (such as slope) of the load line based on the type of processor mounted on the circuit board. The adjusting mechanism 300 may sense the signal on the signal line 135 and appropriately control the impedance within the feedback of the voltage regulating device. This operates to change characteristics of the load line of the voltage regulating device. Accordingly, depending on the type of processor (such as the first processor or the second processor) coupled to the circuit board, load line characteristics may be changed within the voltage regulating device. As would be understood to one skilled in the art, load line characteristics may include a slope of the line as well as voltage and current characteristics, impedances, etc..

The adjusting mechanism 300 may thereby identify the type of processor coupled to the platform. The signal output from the adjusting mechanism may control elements of the feedback path to set the output voltage. The adjusting mechanism 300 may also be called a programmable dual load line.

FIG. 5 is a circuit diagram of an example embodiment of the present invention. Other embodiments and configurations are also within the scope of the present invention. The circuit diagram of FIG. 5 shows a detailed structure of one example adjusting mechanism. More particularly, FIG. 5 shows one example of a circuit to provide the adjusting mechanism 300. The adjusting mechanism 300 may include a select signal line 310, resistors 312 and 316, a transistor 314, and a capacitor 318. The select signal line 310 may correspond to the signal line 135 discussed above. The select signal line 310 may also be called a processor select line.

As discussed above, the adjusting mechanism may adjust characteristics of a load line based on the signal output of a package pin from a processor coupled to the package. For example, a HIGH signal or level may represent a first processor and a LOW signal or level may represent a second processor. In order to represent these two potential states, FIG. 5 shows a virtual switch 320 coupled to the select signal line 310. The virtual switch 320 may be coupled to either one of two virtual terminals 322 and 324. The virtual terminal 322 may represent a (HIGH or floating) signal whereas the virtual terminal 324 may represent a low (or ground) signal. In other words, when the first processor is coupled to the package, then the circuit can be represented as the switch 320 coupled to the terminal 322. On the other hand, when the second processor is coupled to the package, then the circuit may be represented as the switch 320 coupled to the terminal 324.

As will now be described, depending on the position of the virtual switch 320, the signal line 310 (or the signal line 135) may be coupled to a different potential. This different potential may thereby adjust characteristics of the load line by changing the impedance of the feedback to the voltage regulating device. More specifically, the adjusting mechanism, including components such as the select signal line 310, the resistors 312 and 316, the transistor 314, and the capacitor 318 may adjust the load line characteristics based on the signal input along the signal line 310 (or signal line 135). Adjusting the load line characteristics may correspond to changing the slope and/or voltage/current characteristics.

The circuit shown in FIG. 5 may set the adaptive droop depending on which processor is installed on the package (or other entity). The resistor Rscale and the capacitor Cscale may represent passive components used to set the adaptive droop using the voltage controller VRC. The adjusting mechanism including the resistors 312 and 316 and the transistor 314 may be coupled to a select pin on the processor. When the first processor is installed (shown in FIG. 5 as the virtual switch 320 connected to the terminal 324), then the base of the transistor 314 is coupled to GROUND and the resistor Rscale and the capacitor Cscale are in parallel with the capacitor 318 so as to set the voltage regulator's adaptive droop. On the other hand, when the second processor is installed (shown in FIG. 5 as the virtual switch 320 connected to the terminal 322), then the floating transistor 314 switches in the resistor 316 and the resistor 312 in parallel with the resistor Rscale and the capacitor Cscale so as to set the voltage regulator's adaptive droop.

Other circuits for forming the adjusting mechanism are also within the scope of the present invention. For example, different voltage regulator controllers may require different combinations of resistors and capacitors. The selection of components may add variations to the resulting load line and this may affect the overall performance of the system.

Embodiments of the present invention are also applicable to an adjusting mechanism that distinguishes among a plurality of processors such as three or more processors and appropriately adjusts load line characteristics based on the type of processor coupled to the platform. This may involve the monitoring of more than one pin on the attached processor.

Embodiments of the present invention encompass arrangements (methods, circuits, systems, etc.) which adjust/adapt non-voltage and/or non-current level characteristics (impedances, droop, etc.) of a load line, irregardless of whether or not there are other arrangements which adjust/adapt a voltage and/or current to be output on the load line.

Any reference in this specification to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment or component, it is submitted that it is within the purview of one skilled in the art to effect such feature, structure, or characteristic in connection with other ones of the embodiments or components. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A method comprising:
determining a type of processor installed; and
adjusting characteristics of a load line to power the processor based on the determined type of processor.

2. The method of claim 1, wherein determining the type of processor comprises sensing at least one of an output and level from a pin of the processor.

3. The method of claim 1, wherein adjusting characteristics of the load line comprises changing an impedance of feedback from the processor to a voltage regulating device.

4. The method of claim 1, further comprising powering the processor using the adjusted characteristics of the load line.

5. The method of claim 4, wherein the load line comprises a relationship of current and voltage.

6. The method of claim 1, wherein adjusting characteristics of the load line comprises changing a relationship of input current to output voltage.

7. A method comprising:
powering a processor;
sensing one of a signal and a level output from the processor; and
adjusting powering characteristics based on the sensed one of the signal and the level output from the processor.

8. The method of claim 7, wherein the powering characteristics comprise load line characteristics.

9. The method of claim 8, further comprising powering the processor using the adjusted load line characteristics.

10. The method of claim 7, wherein adjusting the powering characteristics comprises changing a relationship of input current to output voltage.

11. A package comprising:
a voltage regulating device to output a voltage based on an input current and a load line; and
a processor coupled to the voltage regulating device to be powered by the voltage output from the voltage regulating device, the package including a mechanism to determine a type of processor coupled to the package and to adjust characteristics of the load line based on the determined type of processor.

12. The package of claim 11, wherein the mechanism is provided within the voltage regulating device.

13. The package of claim 11, wherein the mechanism is provided at least partly external from the voltage regulating device.

14. The package of claim 11, wherein the mechanism comprises a circuit to sense one of an output and a level from a pin of the processor and to provide a signal based on the sensed one of the output and the level.

15. The package of claim 14, wherein the circuit comprises at least a transistor and a resistor, the transistor to operate differently depending on the sensed output from the pin.

16. The package of claim 14, wherein the circuit is provided in a feedback path between the processor and the voltage regulating device.

17. A device comprising:
a powering device to power a processor based on load line characteristics, the powering device to operate based on a sensed one of an output signal and a level of the processor.

18. The device of claim 17, wherein the device includes a sensing device to sense the one of the output signal and the level of the processor.

19. The device of claim 18, wherein the sensing device is provided within the powering device.

20. The device of claim 18, wherein the sensing device is provided external from the powering device.

21. The device of claim 18, wherein the sensing device comprises a circuit to sense one of an output and said level from a pin of the processor and to provide a signal based on the sensed one of the output and the level.

22. The device of claim 21, wherein the circuit comprises at least a transistor and a resistor, the transistor to operate differently depending on the sensed one of the output and the level from the pin.

23. The device of claim 21, wherein the circuit is provided in a feedback path between the processor and the powering device.

24. A method comprising:
determining a type of integrated circuit installed; and
adjusting characteristics of a load line to power the integrated circuit based on the determined type of integrated circuit.

25. The method of claim 24, wherein determining the type of integrated circuit comprises sensing at least one of an output and a level from a pin of the integrated circuit.

26. The method of claim 24, wherein adjusting characteristics of the load line comprises changing an impedance of feedback from the integrated circuit to a voltage regulating device.

27. The method of claim 24, further comprising powering the integrated circuit using the adjusted characteristics of the load line.

28. The method of claim 27, wherein the load line comprises a relationship of current and voltage.

29. The method of claim 24, wherein adjusting characteristics of the load line comprises changing a relationship of input current to output voltage.

30. A device comprising:
a powering device to power an integrated circuit based on load line characteristics, the powering device to operate based on a sensed at least one of an output signal and a level of the integrated circuit.

31. The device of claim 30, wherein the device includes a sensing device to sense the one of the output signal and the level of the integrated circuit.

32. The device of claim 31, wherein the sensing device is provided within the powering device.

33. The device of claim 31, wherein the sensing device is provided external from the powering device.
